(19) United States
(12) Patent Application Publication
(10) Pub. No.: US 2003/0226147 A1
(43) Pub. Date: Dec. 4, 2003

(54) Associating an electronic program guide (EPG) data base entry and a related internet website

(76) Inventors: Michael S. Richmond, Beaverton, OR (US); Paul Pilat, Portland, OR (US); Mary D. Smiley, Beaverton, OR (US)

Correspondence Address: Mark S. Peloquin, Blakely, Sokoloff, Taylor & Zafman LLP, Seventh Floor, 12400 Wilshire Boulevard, Los Angeles, CA, 90025-1030, US

(21) Appl. No.: 10/159,378

(22) Filed: May 31, 2002

(51) Int. Cl. G06F 3/00; H04N 5/445; G06F 13/00

(52) U.S. Cl. 725/51; 725/53

(57) ABSTRACT

A method includes performing an Internet search for an Internet address based on a keyword, wherein the keyword is obtained from an electronic program guide item of an electronic program guide. The Internet address is received and the keyword and the Internet address are associated together. An information display includes a first area containing an electronic program guide item and a second area containing an indicia of a related Internet address.

### BACKGROUND

1. Field

Embodiments of the invention relate generally to the field of multimedia and more specifically to associating electronic program guide contents with related Internet sites.

2. Background

Television program content is provided to a consumer by means that are well known in the art. Some examples of providing television content include cable television and satellite television. These existing systems contain many channels, typically over one hundred, and use an electronic program guide to indicate the time and channel that a television program will be broadcast. An example of a portion of an existing electronic program guide is shown in FIG. 1 at 100. The electronic program guide includes many electronic program guide items as seen in the portion of the electronic program guide displayed at 100. An electronic program guide item 10 indicates that a Buzz Lightyear show titled “Conspiracy” will be broadcast at 4:30 PM on channel 7.

Existing electronic program guides, such as the one shown in 100, do not provide information to a user about Internet sites that are related to the electronic program guide items. Existing electronic program guides do not associate related Internet sites with items in the electronic program guides. Users have no ability to access related Internet content from existing electronic program guides.

### BRIEF DESCRIPTION OF THE DRAWINGS

The invention may best be understood by referring to the following description and accompanying drawings that are used to illustrate embodiments of the invention. The invention is illustrated by way of example and is not limited in the figures of the accompanying drawings, in which like references indicate similar elements. In the drawings:

FIG. 1 illustrates an existing electronic program guide.

FIG. 2A displays a hardware architecture.

FIG. 2B illustrates process blocks for a method to associate an electronic program guide with related Internet content.

FIG. 3 illustrates process blocks for another method of associating an electronic program guide with the related Internet content.

FIG. 4 depicts an association of an electronic program guide element and the corresponding Internet content.

FIG. 5 illustrates a graphical association of Internet content with an electronic program guide.

FIG. 6 is one embodiment of manipulating an icon to display related Internet content.

FIG. 7 is another embodiment of manipulating an icon to display related Internet content.

### DETAILED DESCRIPTION

In the following detailed description, numerous specific details are set forth. However, it is understood that embodiments of the invention may be practiced without these specific details. In other instances, well-known circuits, structures, and techniques have not been shown in detail in order to not obscure the understanding of this description. These embodiments are described in sufficient detail to enable those of ordinary skill in the art to practice the invention. The following detailed description is, therefore, not to be taken in a limiting sense, and the scope of the invention is defined only by the appended claims.

Electronic program guide items from an electronic program guide (EPG) are associated with related Internet content and are made available to a user. In one embodiment of the invention, the related Internet content can be accessed by clicking on an icon, which opens a window containing a link to the related Internet site(s). In another embodiment, the electronic program guide item and the related Internet site(s) are stored in a memory. Within this description, the association of the electronic program guide items and the related Internet site(s) and/or content can occur when the user is presented with an electronic program guide item and indicia of the related Internet site(s) and/or content. The indicia of the related Internet site(s) and/or content can be in the form of an icon on an information display or a voice enabled software application that is responsive to voice input. User interaction with the indicia of the related Internet site(s) and/or content can trigger a process that performs the search to find the related Internet site(s) and/or content. Throughout this description the terms Internet address, Internet site, and/or content will be used interchangeably.

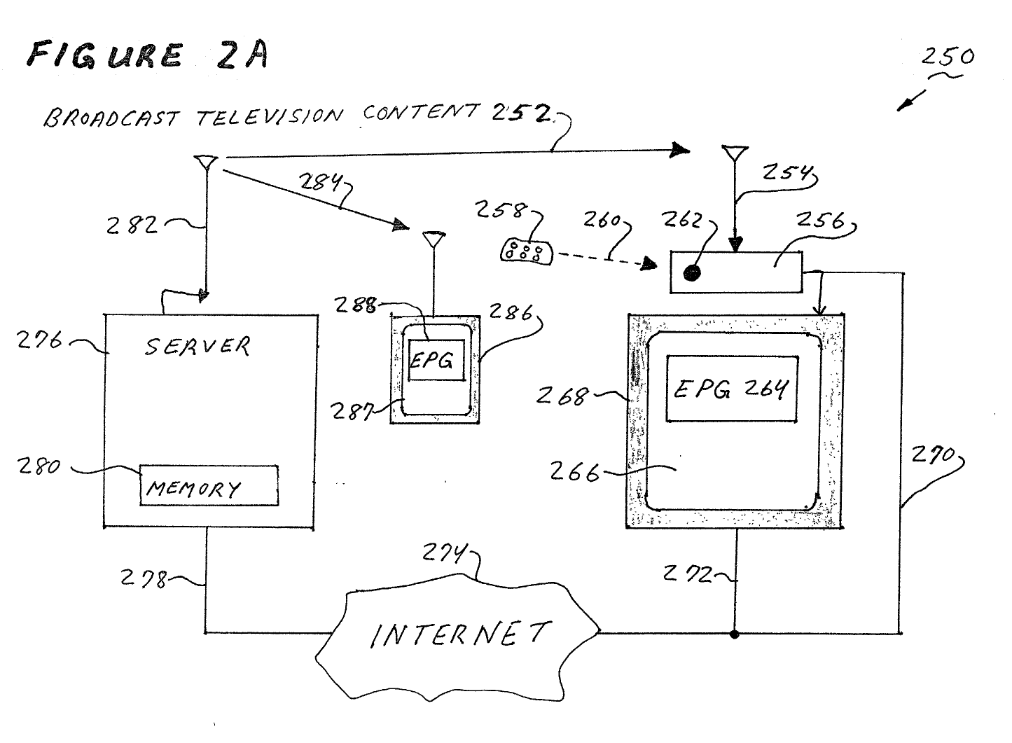

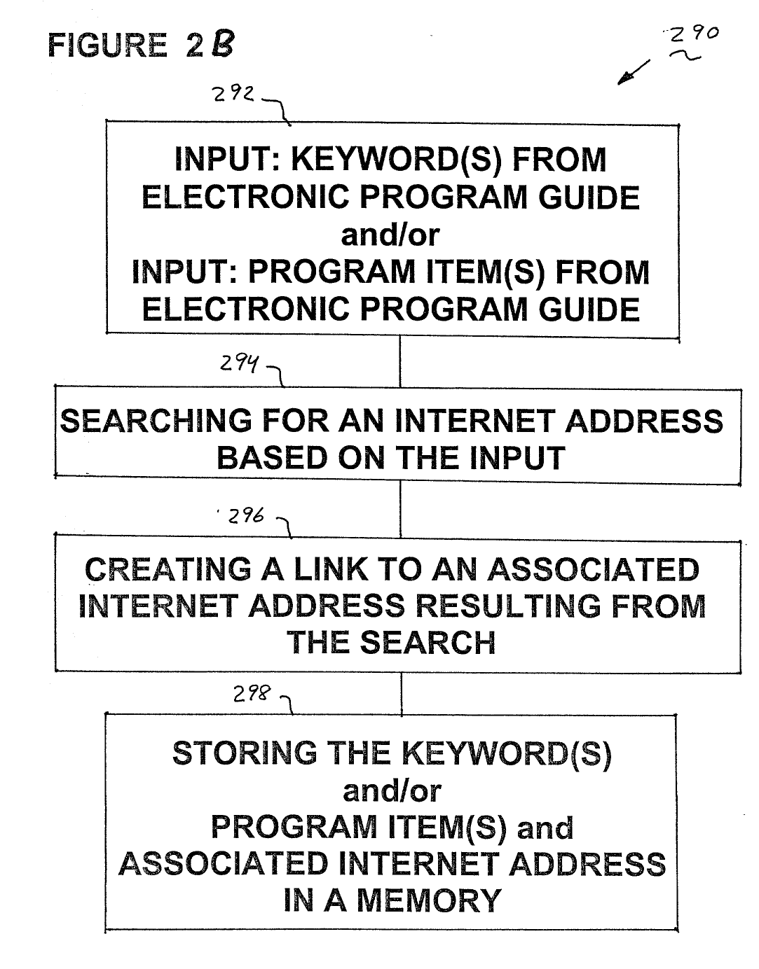

In one embodiment of the invention, FIG. 2A displays a hardware architecture at 250. With reference to FIG. 2A, a broadcast television content 252, containing an electronic program guide (EPG) and the association of the EPG items and the related Internet site(s) and/or content, is broadcast and received at 254 and is input to a set-top box 256. The set-top box 256 is configured with a remote control 258. Communication between the remote control 258 and the set-top box 256 is usually accomplished using a wireless communication link such as an infrared communication link as indicated by 260 and a corresponding sensor 262 and associated circuitry (not shown). The set-top box 256 is connected with a display device 268; the display device 268 has an information display 266. Information display 266 can be any display suitable for displaying 252. A non-limiting list of suitable information displays includes, a tube type display, a flat panel type of display such as a liquid crystal display (LCD), etc. The invention is not limited by the type of display used to display 252. At 264, an electronic program guide (EPG) and the association of the EPG items and the related Internet site(s) and/or content is displayed on the information display 266.

Broadcast television content 252 can be transmitted by various transmission methodologies that are known to those of ordinary skill in the art, such as by coaxial cable, fiber optic cable, open air/space terrestrial or satellite signal broadcasts, or other suitable means of transmitting 252 to 254. Receiver 254 is suited for the type of transmission that is intended for reception by the set-top box 256.

The set-top box 256 is connected to the Internet 274 either directly as shown by 270 or by a connection 272 via the display device 268, if the display device 268 is so configured with a connection to the Internet 274. Connections made to the Internet by 256, 268, 286, and 276 can either be wired or wireless as is known by those of ordinary skill in the art. Server 276, having a memory 280, provides broadcast television content to transmission means 282. Transmission means 282 is appropriate to transmit broadcast television content 252 according to the particular transmission methodology implemented by within a given system design.

In another embodiment of the invention, an electronic program guide (EPG) and the association of the EPG items and the related Internet site(s) and/or content can be broadcast at 284 and be received by a device 286. Device 286 can be similar to a one-way pager or a portable television that has an information display 287. At 288, the electronic program guide (EPG) and the association of the EPG items and the related Internet site(s) and/or content can be displayed on the information display 287 in a non-interactive environment.

In yet another embodiment, the device 286 can be a device that is capable of making a connection (not shown) with the Internet 274. The association of the EPG items and the related Internet site(s) and/or content can be displayed on the information display 287. The related Internet site(s) and/or content and be accessed from the device 286 through the connection (not shown) with the Internet 274 in an interactive environment.

In FIGS. 2B-7 that follow, 264 and 288 from FIG. 2A can be similar to the descriptions of the EPG and the associations of the EPG items and the related Internet sites(s) and/or content contained in FIGS. 2B-7.

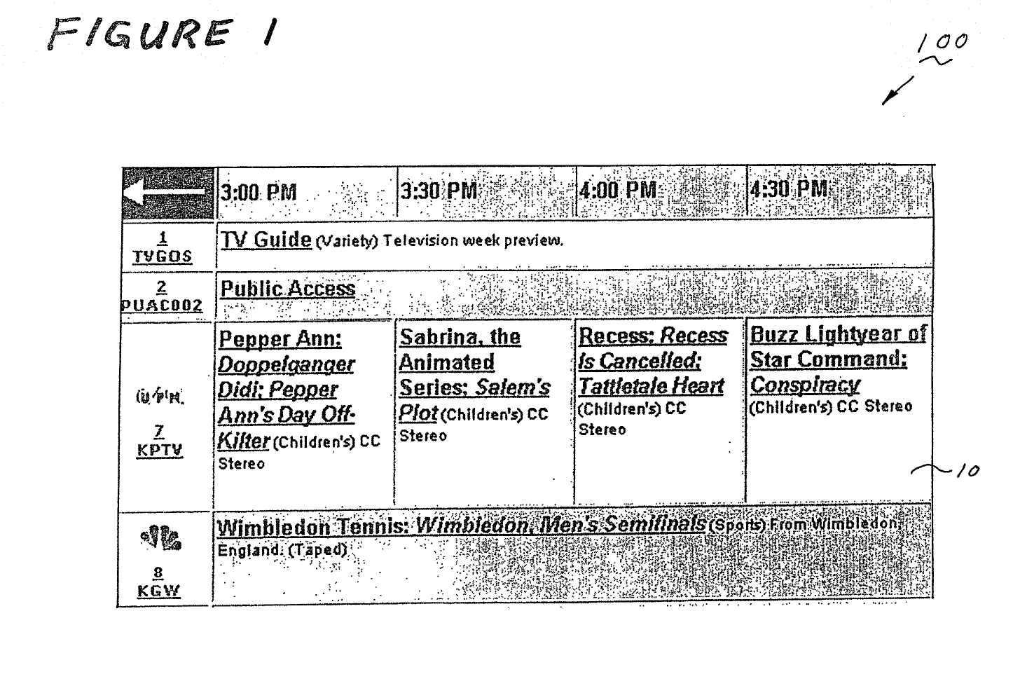

A method of associating entries from an electronic program guide (EPG) and the related Internet site(s) is shown in FIG. 2B at 290. With reference to FIG. 2B, an input to the method is shown at block 292. Input refers to information related to the program, within the electronic program guide (EPG), that is designated for broadcast at a given time and channel. For example, in FIG. 1, the Buzz Lightyear program is scheduled for broadcast on channel 7 at 4:30 PM, as indicated by an electronic program guide item 10. Designation of the Buzz Lightyear program, as an input to the method can range from a keyword, taken from the text used to describe an electronic program guide item, to the entire description of the electronic program guide item. In the context of this discussion, a keyword will be taken to represent a word, or a part thereof, of the electronic program guide item, 10, of the electronic program guide 100 (FIG. 1). Various keywords can be taken from the text shown in block 10. A list of non-limiting examples includes “Buzz Light,” “Buzz Lightyear,” “Buzz Lightyear of Star Command,” “Buzz Lightyear Conspiracy,” etc. Those of ordinary skill in the art will recognize other keywords that can be selected from the text that makes up the electronic program guide item. The present invention is not limited by the key words that are selected from the electronic program guide.

Keywords or parts thereof, taken from the text used to describe a program guide item, can be input automatically by the system architecture transparent to the user. Alternatively, the user can be required to participate in the input process. Participation by the user in the input process can range from full control to partial control, depending on how the user interface is configured. An example of user participation is provided below in the discussion of the voice enabled user interface. The user can be given the ability to refine or widen the scope of the search as well. The present invention is not limited by the way in which input is supplied to the method at block 292.

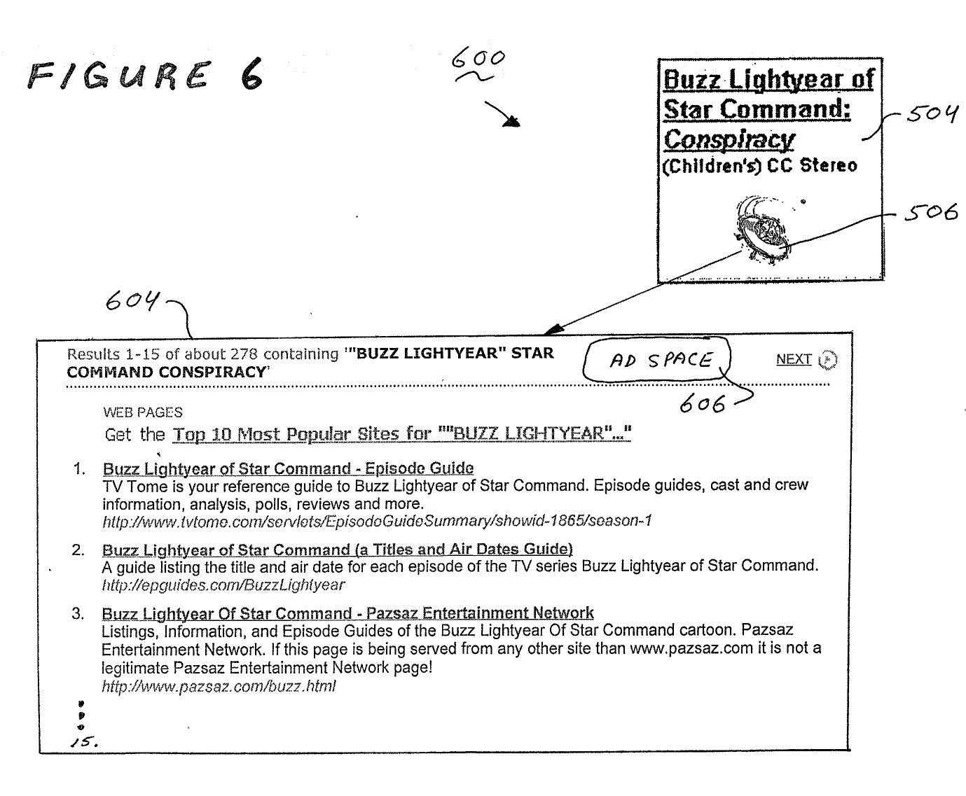

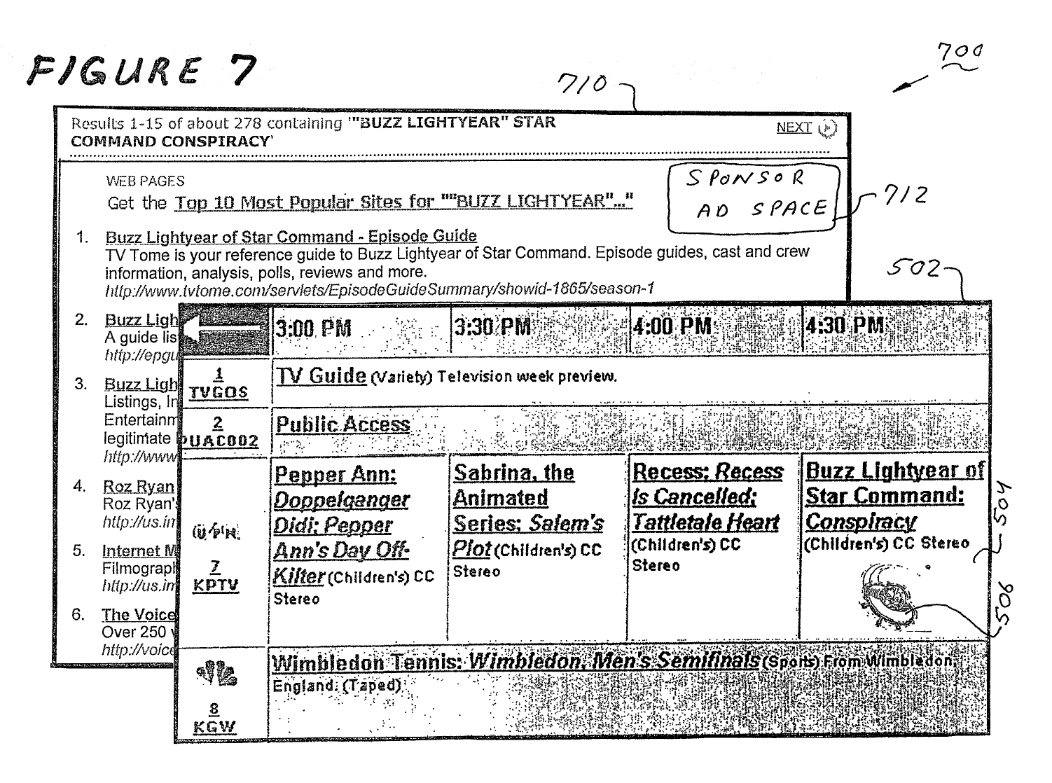

With reference back to FIG. 2B, in one embodiment, the input 292, to the search process, results in a search for an Internet address based on the input at 294. It will be apparent to those of ordinary skill in the art that the search can be for more than one address. Typically, a search of the Internet produces many resulting Internet addresses. In practice, it will often be the case that a plurality of related Internet sites are found during the search process, as can be seen below in FIG. 6 at 604 and FIG. 7 at 710. Within the remainder of this description, the singular form of address will be used, however, no limitation is implied thereby. For example, if the input keywords are “‘Buzz Lightyear’ Star Command Conspiracy,” process block 294 searches for a related site(s). Searching for a related Internet site can be performed by any means known in the art, such as using search services provided by companies such as Google™, Yahoo™, and Netscape™. Alternatively, a dedicated search engine, special purpose search engine, or limited special purpose search engine can be included in an embodiment of the invention. The invention is not limited by the way in which the search is performed for the Internet site(s) and/or content. Following the search at 294, a link is created to the Internet site(s) at 296. In one embodiment of the invention, the input and/or electronic program guide item and the related Internet address is associated when stored in a memory at 298. For example, the input and/or electronic program guide item and the related Internet site(s) is/are stored in the memory 280 in FIG. 2A.

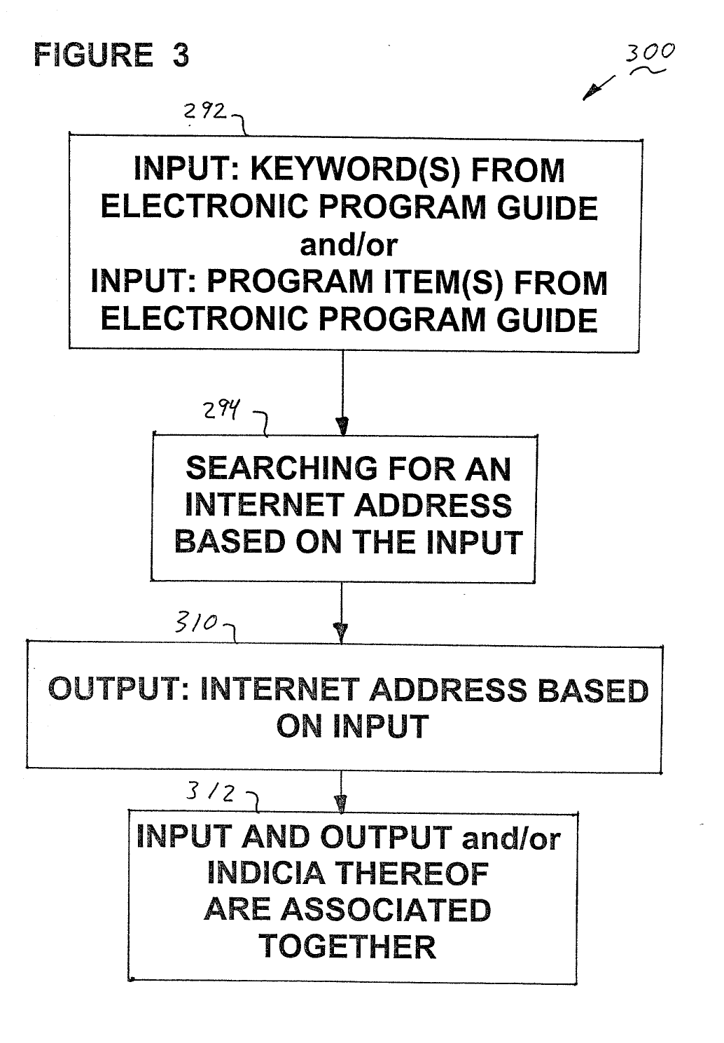

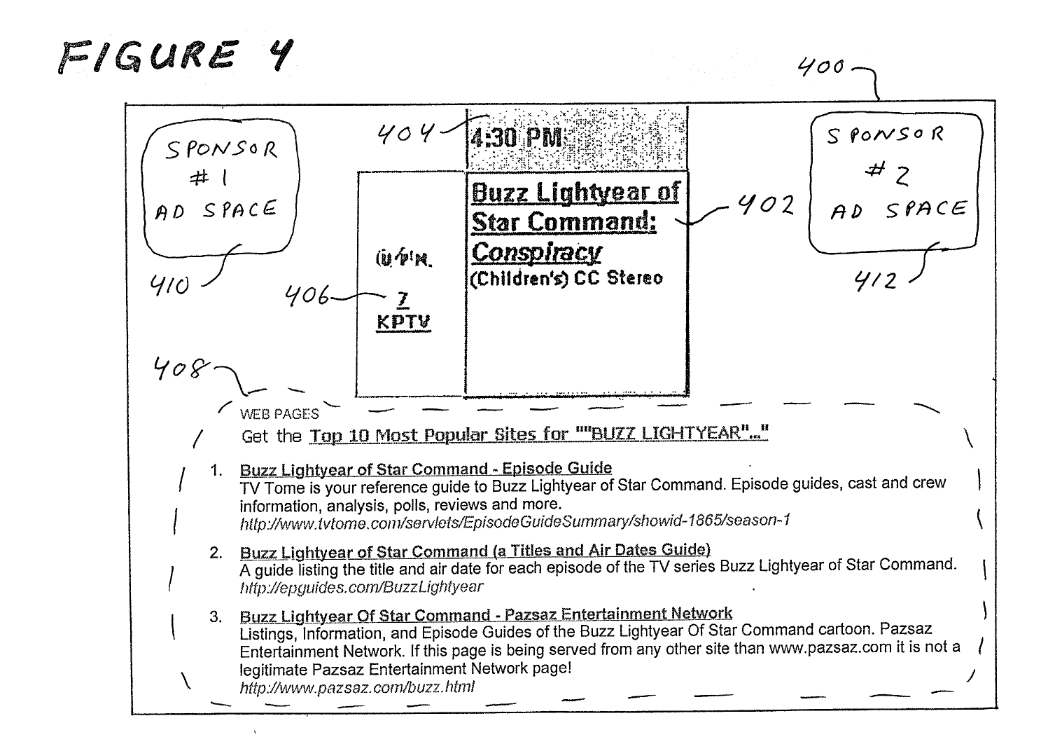

In another embodiment of the invention, a method of associating an electronic program guide with the related Internet content is shown in FIG. 3. As previously described, in conjunction with FIG. 2B, an input 292 is used to search for an Internet address at 294. An output of the search 310 results in an Internet address, or a link to the Internet address. As was mentioned above, there can be a plurality of Internet addresses that are associated with the input to the search, however, for clarity, reference is made to one address during the remainder of this description unless a specific example indicates otherwise. The input and the output are then associated together at 312. Associating the input and the output together can be done in different ways. A non-exclusive list of ways of performing the association will be described below in conjunction with FIG. 4 through FIG. 7.

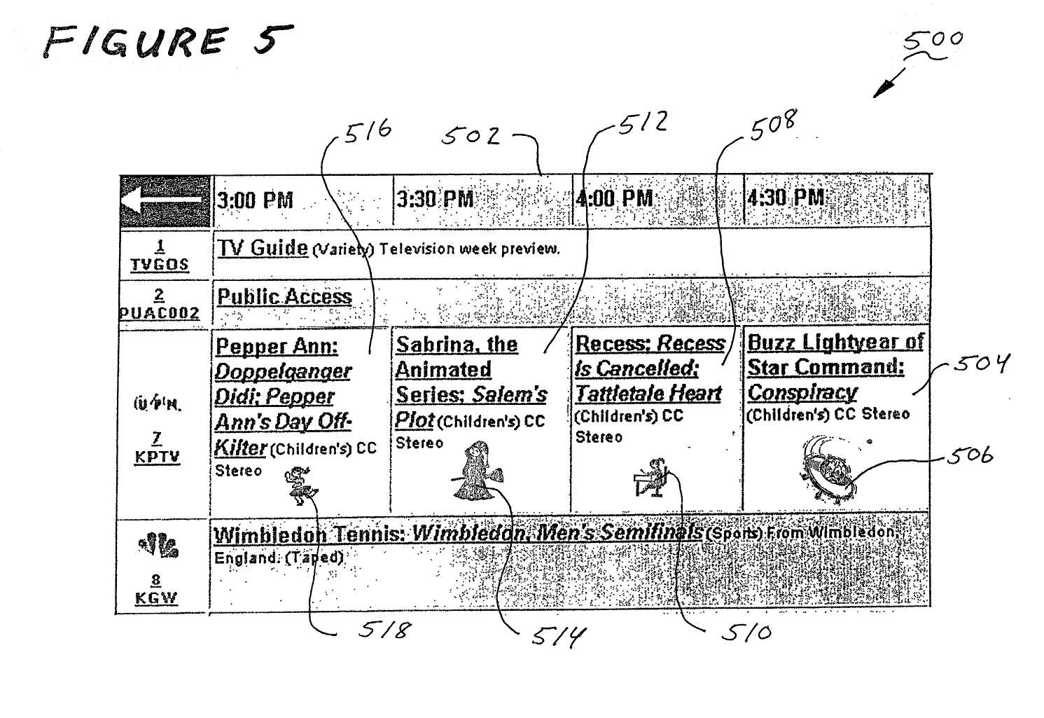

In yet another embodiment of the invention, FIG. 4 depicts an association of an electronic program guide item with corresponding Internet sites and/or content. An association, shown in 400, is made between an electronic program guide item 402 and related Internet sites 408. Broadcast time 404 and channel indicator 406 may be displayed optionally to indicate more precisely when the electronic program guide item 402, from the electronic program guide 502 in FIG. 5, can be viewed.

Other embodiments of the invention (not shown) include displaying the electronic program guide input keywords that were used for the search or other keywords from the electronic program guide item that were not used for the search. The association, between the electronic program guide item and the related Internet sites(s) requires some indicia of the electronic program guide item to be associated with some indicia of the related Internet site address and/or Internet site content. Another example of an association, according to an embodiment of the present invention, is having Internet site content displayed in 408 (FIG. 4) instead of the Internet site summaries and addresses as presently shown.

The association shown in 400 can be displayed on a suitable information display in either an interactive or non-interactive environment. Suitable information displays include those used on computing devices, interactive televisions, or non-interactive televisions. A non-exclusive list of computing devices includes, but is not limited to, a laptop computer, a personal data assistant, a tablet, a cellular telephone, a global positioning system, and a vehicular display. The present invention is not limited by the type of information display used to display the association between the electronic program guide items and the relevant Internet site(s) and/or content. The association shown in 400 can be displayed in a non-interactive environment. In such a non-interactive environment, the relevant Internet site(s) can be grouped proximate to the corresponding electronic program guide item to aid in the association. In one embodiment, referring back to FIG. 2A, the device 286 can be used to provide a non-interactive environment when the device 286 does not have a communication channel that provides access to the Internet 274 or the server 276. A non-interactive environment is characterized by a unidirectional flow of information to the user. The user has no means of creating a response or output in response to the input information 252 or 284. An example of a non-interactive environment is a non-interactive television set or a one-way pager device. Alternatively, an interactive environment provides the user with the means to create an output in response to an input. The user can use the remote control 258 to provide input that is communicated via 270 or 272 and 278 to the Internet 274 to interact with the related Internet sites(s), in an interactive environment. As described above in conjunction with FIG. 2A the device 286 can make a connection (not shown) with the Internet to allow the user to interact with the related Internet site(s) in an interactive environment. The device 286 can be provided with a suitable interface by which input is accepted from the user such as a keypad or by voice recognition.

Referring back to FIG. 4, in one or more embodiments of the invention, advertisement space can be sold or leased. The association shown in 400 can be presented within a window of an information display or within the entire information display. A region of the information display, represented by 400, can be assigned to advertising. A region 410 can be leased or sold to a first sponsor or entity and a region 412 could be leased or sold to a second sponsor or entity. An advertisement from the first sponsor or entity can be displayed in the region 410 and an advertisement from the second sponsor or entity can be displayed in the region 412. The advertisement(s) from the sponsors or entities can be stored in a memory along with the keywords or parts thereof from the program items and the related Internet site(s) and/or content. A non-limiting example of a suitable memory is the memory 280 as shown in FIG. 2A. The arrangement of 400 into the areas 402, 404, 406, 408, 410, and/or 412 is flexible; the present invention is not limited thereby. The distribution of areas shown in FIG. 4 is merely an illustration of one embodiment of the present invention.

FIG. 5 illustrates, at 500, a graphical association of Internet content with an electronic program guide. With respect to FIG. 5, an electronic program guide 502 is shown containing electronic program guide items as a function of time and channel. An electronic program guide item 504 for the “Buzz Lightyear” program is shown. In one embodiment, icon 506 provides access to Internet sites that are associated with “Buzz Lightyear” in an interactive environment. An interactive environment can receive input from a user as previously described. Examples of interactive environments include but are not limited to properly configured computing devices such as a laptop computer, a desktop computer, a personal data assistant such as an iPAQ™ or a Palm™ computing device, a tablet, a cellular telephone, a global positioning system, etc. A non-interactive television can be combined with a set-top box to provide the second communication link required to turn the non-interactive television into an interactive television. Such methods of incorporating a set-top box with a non-interactive television are well known in the art.

In one embodiment of the invention, the association present within 500 combines text from a program guide item 504 and an icon 506. The icon 506 points to relevant Internet sites that either have already been found by means of an Internet search or will be found by means of an Internet search once a search is triggered by the user or an ancillary process triggered by the user's selection of icon 506. For example, triggering or selecting icon 506 with a pointing device can launch a window containing Internet sites related to “Buzz Lightyear,” as described below in conjunction with FIG. 6. Referring back to FIG. 5, similar functionality exists between the other icons 510, 514, 518 and the corresponding electronic program guide items 508, 512, and 516. Triggering icon 510 would display Internet site(s) and/or content relevant to the electronic program guide item 508, triggering icon 514 would display Internet site(s) and/or content relevant to the electronic program guide item 512, and triggering icon 518 would display Internet site(s) and/or content relevant to electronic program guide item 516.

The description of operation of the user interface is not limited to selecting an icon with a pointing device such as a mouse or a stylus; voice recognition can be used to select the relevant Internet site(s) and/or content. For example, in one embodiment of the invention, the electronic program guide can be configured without a visual designation of the indicia of the related Internet site(s) and/or content. Another form that the indicia of the related Internet site(s) and/or content can take is that of a voice enable software application program. The user could simply speak a part of a keyword or one or more keywords from an electronic program guide item such as “Buzz Lightyear.” Speaking the keywords could perform the same method of triggering a search or displaying the results of a search as was described above. The user interface can be configured with a voice recognition input, as is known in the art, to receive a speech signal, convert the speech signal into text and then direct the text as input to the Internet search process as previously described. In this embodiment, the association of the electronic program guide item and the related Internet site(s) and/or content is made by combining the electronic program guide item and the speech enabled application program responsive to user input of keywords and output of the related Internet site(s) and/or Internet content. The present invention is not limited by the way in which the user triggers the process to display or collect the relevant Internet site(s) and/or content that is related to the electronic program guide item.

In one embodiment of the invention, as shown in FIG. 6, an icon is manipulated to display related Internet content. With respect to FIG. 6, the flying saucer icon 506 indicates the Internet site(s) and/or content that are related to the electronic program guide item 504. In other embodiments, a button labeled “I-NET,” or “NET” could be used or as described above, no button or icon need be present to perform the relevant association of the electronic program guide item and the Internet site(s) and/or content. Manipulating icon 506 results in the display of Internet site(s) as shown in 604. Alternatively, speaking relevant keywords from the electronic program guide item could provide input to an Internet search or could display the results of a previous search. The user could speak “Internet” “Net” or any other word or phrase which could be used to determine that the user wanted to see the Internet site(s) or content related to the particular electronic program guide item. An example of this kind of functionality could be a phrase like “Channel 7 at 4:30 PM,” which the user would speak resulting in the corresponding Internet site(s) and/or content being displayed.

An area within 604 can be used for advertisement space, as indicated by 606. Advertisement space 606 can be sold or leased to one or more sponsors or entities; an advertisement can be placed therein. In one embodiment, a plurality of entities (contracting parties) could pay for the use of 606 for an interval of time, for example 10 seconds every out of every minute that 604 was displayed. As 604 remained on the information display, the user would see information from each of the plurality of sponsors appear in serial fashion, one after the other on a 10 second interval. Many other methods of associating and displaying information from the entities are possible; the method described above is but one example. The present invention is not limited by the way in which the advertisement space is managed, leased, sold, or displayed. Within this description, sponsors, entities, and contracting parties can be used interchangeably, no restriction is intended by the use of one term over the other.

Information displays can be configured in various ways to provide the association between the electronic program guide item and the Internet site(s) or content. FIG. 7 illustrates another embodiment of manipulating an icon to display related Internet content at 700. Two windows are shown in FIG. 7, the electronic program guide 502 in a first window and the Internet content related to the electronic program guide item 504 in a second window 710. It will be apparent to those of skill in the art that many ways exist with which to display the association of the electronic program guide items and the related Internet site(s) or content. The present invention is not limited by the way the related Internet site(s) are displayed or accessed by the user. Advertisement space 712 can be used as described in conjunction with FIG. 4 and FIG. 6 previously.

It will be appreciated that the methods described in conjunction with the figures may be embodied in machine-executable instructions, e.g. software. The instructions can be used to cause a general-purpose or special-purpose processor that is programmed with the instructions to perform the operations described. Alternatively, the operations might be performed by specific hardware components that contain hardwired logic for performing the operations, or by any combination of programmed computer components and custom hardware components. The methods may be provided as a computer program product that may include a machine-readable medium having stored thereon instructions, which may be used to program a computer (or other electronic devices) to perform the methods. For the purposes of this specification, the terms “machine-readable medium” shall be taken to include any medium that is capable of storing or encoding a sequence of instructions for execution by the machine and that cause the machine to perform any one of the methodologies of the present invention. The term “machine-readable medium” shall accordingly be taken to included, but not be limited to, solid-state memories, optical and magnetic disks, and carrier wave signals. Furthermore, it is common in the art to speak of software, in one form or another (e.g., program, procedure, process, application, module, logic . . . ), as taking an action or causing a result. Such expressions are merely a shorthand way of saying that execution of the software by a computer causes the processor of the computer to perform an action or produce a result.

While the invention has been described in terms of several embodiments, those skilled in the art will recognize that the invention is not limited to the embodiments described, but can also be practiced with modification and alteration within the spirit and scope of the appended claims. The description is thus to be regarded as illustrative instead of limiting. Accordingly, all such variations and modifications are included within the intended scope of the invention as defined by the following claims.

What is claimed is:

1. A method comprising:
searching for an Internet address, wherein the searching is based on a keyword, wherein the keyword is obtained from an electronic program guide item within an electronic program guide (EPG);
creating a link to an Internet address based on a result of the searching for the Internet address; and
storing the keyword and the Internet address in a memory.

2. The method of claim 1, further comprising displaying, on an information display, the keyword from the EPG and the link to the Internet address.

3. The method of claim 1, further comprising:
storing an advertisement with the keyword and the Internet address in the memory.

4. A method comprising:
searching for an Internet address, wherein the searching is based on an electronic program guide item of an electronic program guide (EPG);
creating a link to an Internet address based on a result of the searching for the Internet address; and
storing the electronic program guide item and the Internet address in a memory.

5. The method of claim 4, further comprising displaying, on an information display, the electronic program guide item from the EPG and the link to the Internet address.

6. The method of claim 4, further comprising:
storing an advertisement with the electronic program guide item and the Internet address in the memory.

7. A method comprising:
submitting a search request for an Internet address based on a keyword, wherein the keyword is related to an electronic program guide item of an electronic program guide (EPG);
receiving an Internet address in response to the submitting the search request; and
associating the keyword and the Internet address together.

8. The method of claim 7, wherein the associating the keyword and the Internet address together causes the keyword and the Internet address to be displayed on an information display.

9. The method of claim 8, wherein the information display is used in a system selected from the group consisting of a television, an interactive television, a desktop computer, a laptop computer, a personal data assistant, a tablet, a cellular telephone, a global positioning system, and a vehicular information display.

10. The method of claim 7, wherein the submitting the search request is sent to a search engine affiliated with a company selected from the group consisting of Google™, Yahoo™, and Netscape™.

11. The method of claim 7, wherein the associating places the keyword and the Internet address within the same window.

12. The method of claim 11, wherein the associating displays the keyword and an icon, wherein manipulation of the icon causes the Internet address to be displayed.

13. The method of claim 7, wherein the associating places the Internet address in a separate window from the keyword that was used to perform the search request.

14. The method of claim 7, wherein the associating further comprises selling a right to include an advertisement, for a period of time, with the keyword and the Internet address.

15. An apparatus comprising:
an electronic program guide;
a electronic program guide item contained within the electronic program guide; and
an indicia of an Internet address, wherein the indicia of the Internet address results from an Internet search based on a keyword related to the electronic program guide item.

16. The apparatus of claim 15, further comprising
an information display, wherein the electronic program guide is displayed thereon.

17. The apparatus of claim 15, wherein an advertisement is associated with one selected from the group consisting of the electronic program guide item, the indicia of the Internet address.

18. An apparatus comprising:
an information display;
a first area of the information display containing an electronic program guide (EPG) item; and
a second area of the information display containing an indicia of a related Internet address.

19. The apparatus of claim 18, wherein the related Internet address was selected by searching the Internet using a keyword related to the EPG item.

20. The apparatus of claim 18, wherein manipulation of the indicia of the related Internet address causes content associated with the Internet address to be displayed.

21. The apparatus of claim 18, wherein the information display is used in a system selected from the group consisting of a television, an interactive television, a desktop computer, a laptop computer, a personal data assistant; a tablet, a cellular telephone, a global positioning system, and a vehicular information display.

22. The apparatus of claim 18, wherein the indicia of the related Internet address is an icon.

23. The apparatus of claim 18, wherein the indicia of the related Internet address is a speech enabled application program responsive to a speech input.

24. The apparatus of claim 18, further comprising:
a third area of the information display containing an advertisement.

25. A computer readable medium containing executable computer program instructions, which when executed by a data processing system, cause the data processing system to perform a method comprising:
submitting a search request for an Internet address based on a keyword, wherein the keyword is obtained from an electronic program guide item of an electronic program guide (EPG);
receiving an Internet address in response to the submitting the search request; and
associating the electronic program guide item and the Internet address together.

26. The computer readable medium as set forth in claim 25, wherein the associating the electronic program guide item and the Internet address together causes the electronic program guide item and the Internet address to be displayed on an information display.

27. The computer readable medium as set forth in claim 26, wherein the information display is used in a system selected from the group consisting of a television, an interactive television, a desktop computer, a laptop computer, a personal data assistant; a tablet, a cellular telephone, a global positioning system; and a vehicular information display.

28. The computer readable medium as set forth in claim 25, wherein the submitting the search request is sent to a company selected from the group consisting of Google™, Yahoo™, and Netscape™.

29. The computer readable medium as set forth in claim 25, wherein the associating displays the electronic program guide item and an indicia of the Internet address, wherein manipulation of the indicia of the Internet address causes the Internet address to be displayed.
